(19) United States
(12) Patent Application Publication
(10) Pub. No.: US 2013/0171998 A1
(43) Pub. Date: Jul. 4, 2013

(54) Method, Micro Base Station, and Communications System for Creating Microcell

(71) Applicant: HUAWEI TECHNOLOGIES CO., LTD., Shenzhen (CN)

(72) Inventors: Sheng Liu, Shenzhen (CN); Wenshuan Dang, Shenzhen (CN); Hong Cheng, Shenzhen (CN); Wei Fan, Shenzhen (CN)

(73) Assignee: HUAWEI TECHNOLOGIES CO., LTD., Shenzhen (CN)

(21) Appl. No.: 13/780,976

(22) Filed: Feb. 28, 2013

Related U.S. Application Data
(63) Continuation of application No. PCT/CN2011/074858, filed on May 30, 2011.

(30) Foreign Application Priority Data
Aug. 31, 2010 (CN) 201010270706.1

(51) Int. Cl. H04W 84/04

(52) U.S. Cl. CPC H04W 84/045
USPC 455/446; 455/562.1

(57) ABSTRACT

A method, a micro base station, and a communications system for creating a microcell are disclosed in the present application. The method includes: configuring, by a micro base station, beam width and beam directions of high-gain directional antennas according to location information about hotspot areas in at least two macrocells; and using, by the micro base station, at least two beams formed by the high-gain directional antennas to form microcell coverage over the hotspot areas in the at least two macrocells. In the embodiments of the present application, the location of the micro base station may be kept unchanged when locations of hotspot areas in a plurality of macrocells change, and by adjusting the beam width and beam directions of high-gain directional antennas, the micro base station can provide microcell coverage over the changed hotspot areas, thereby making the networking flexible and reducing the network maintenance cost.

### CROSS-REFERENCE TO RELATED APPLICATIONS

This application is a continuation of International Application No. PCT/CN2011/074858, filed on May 30, 2011, which claims priority to Chinese Patent Application No. 201010270706.1, filed on Aug. 31, 2010, both of which are hereby incorporated by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present application relates to the field of mobile communications technologies, and in particular, to a method, a micro base station, and a communications system for creating a microcell.

### BACKGROUND

Mobile communications networks usually adopt cellular systems; that is, different base stations are built in different areas, and each base station forms a cell to provide communications services for mobile subscribers in the area. On existing mobile communications networks, there are certain hotspot areas that have large communications traffic. A microcell is usually built in a hotspot area to provide a large system capacity for the hotspot area, where communications services are provided for mobile subscribers in the hotspot area by using the microcell.

In the prior art, a mobile communications network is usually a heterogeneous network (HetNet). At first a macro base station is used to create macrocells to provide continuous, wide network coverage in a large area. Then a micro base station is built in a hotspot area to create microcells to provide overlapping coverage for the hotspot area, where the microcells provide a comparatively larger system capacity.

In the process of studying the prior art, the inventor finds that microcells in a hotspot area are created by a micro base station, a proper site in the hotspot area is required to build the micro base station, and backhaul links between the micro base station and a core network are required. If the hotspot area changes, a new site needs to be selected to build the micro base station to form network coverage over the hotspot area. This makes the networking inflexible and increases the network maintenance cost.

### SUMMARY

The present application provides a method, a micro base station, and a communications system for creating a microcell, which may create a microcell covering a hotspot area without reselecting a proper site if the hotspot area changes.

In one aspect, an embodiment of the present application provides a method for creating a microcell, including: configuring, by a micro base station, beam width and beam directions of high-gain directional antennas according to location information about hotspot areas in at least two macrocells; and using, by the micro base station, at least two beams formed by the high-gain directional antennas to form microcell coverage over the hotspot areas in the at least two macrocells.

In another aspect, an embodiment of the present application further provides a micro base station, including: a beamforming module adapted to configure beam width and beam directions of high-gain directional antennas according to location information about hotspot areas in at least two macrocells; and a microcell communications processing module adapted to use at least two beams formed by the high-gain directional antennas to form microcell coverage over the hotspot areas in the at least two macrocells.

An embodiment of the present application further provides a communications system, including: at least two macro base stations and the micro base station, where the at least two macro base stations are adapted to create at least two macrocells and interconnection links are separately configured between the at least two macro base stations and the micro base station.

In the embodiments of the present application, a micro base station may configure beam width and beam directions of high-gain directional antennas according to location information about hotspot areas in macrocells, and directly use beams formed by the high-gain directional antennas to form microcell coverage over the hotspot areas. Compared with the prior art where a new site needs to be selected for a micro base station, in the embodiments of the present application, the location of the micro base station may be kept unchanged when locations of hotspot areas in a plurality of macrocells change, and by adjusting the beam width and beam directions of high-gain directional antennas, the micro base station can provide microcell coverage over the changed hotspot areas, thereby making the networking flexible and reducing the network maintenance cost.

### BRIEF DESCRIPTION OF THE DRAWINGS

To illustrate the technical solutions according to the embodiments of the present application more clearly, accompanying drawings required for describing the embodiments are introduced briefly below. Apparently, the accompanying drawings in the following description are merely some embodiments of the present application, and persons of ordinary skill in the art may further obtain other drawings according to the accompanying drawings without creative efforts.

FIG. 1 is a flow chart of a method for creating a microcell according to a first embodiment of the present application;

FIG. 2 is a schematic diagram of an array antenna according to an embodiment of the present application;

FIG. 3 is a schematic diagram of spatial coordinates of array elements in an array antenna according to an embodiment of the present application;

FIG. 4 is a flow chart of a method for forming microcell coverage over hotspot areas by using beams formed by high-gain directional antennas according to the first embodiment of the present application;

FIG. 5 is a schematic diagram of an equivalent multiple-input multiple-output channel between microcells according to an embodiment of the present application;

FIG. 6 is a schematic diagram of eliminating downlink interference signals in a method for creating a microcell according to an embodiment of the present application;

FIG. 7 is a schematic diagram of eliminating uplink interference signals in a method for creating a microcell according to an embodiment of the present application;

FIG. 8 is a schematic structural diagram of a micro base station according to a second embodiment of the present application;

FIG. 9 is a schematic structural diagram of a microcell communications processing module in the micro base station according to the second embodiment of the present application; and

FIG. 10 is a schematic structural diagram of a communications system according to a third embodiment of the present application.

### DETAILED DESCRIPTION

In order to make the technical solutions according to the embodiments of the present application more comprehensible, the technical solutions according to the embodiments of the present application are clearly and completely described in the following with reference to the accompanying drawings in the embodiments of the present application. Apparently, the embodiments to be described are part of rather than all of the embodiments of the present application. All other embodiments obtained by persons of ordinary skill in the art based on the embodiments of the present application without creative effects shall fall within the protection scope of the present application.

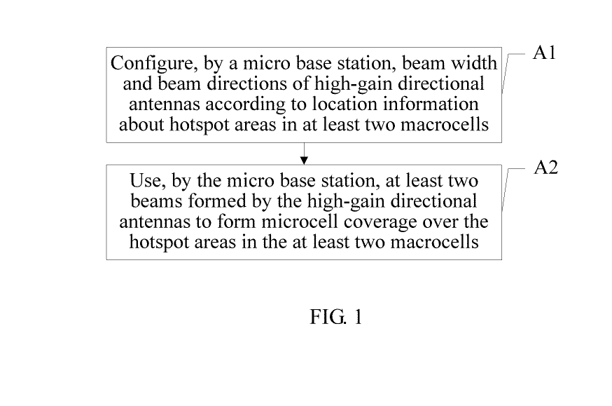

Refer to FIG. 1, which is a flow chart of a method for creating a microcell according to a first embodiment of the present application.

In the embodiment of the present application, seamless and continuous macrocell coverage over an area is provided by at least two macro base stations. The method for creating a microcell based on the coverage of macrocell networks according to the embodiment of the present application may include:

A1. Configuring, by a micro base station, beam width and beam directions of high-gain directional antennas according to location information about hotspot areas in at least two macrocells.

Specifically, the embodiment of the present application may obtain the location information about hotspot areas in the at least two macrocells, and configure the beam width and beam directions of the high-gain directional antennas by using a beamforming algorithm according to the location information of the hotspot areas. Each hotspot area matches a specific beam width and beam direction of a high-gain directional antenna. Beams matching the beam width and beam direction are capable of covering the hotspot area. Location information about a hotspot area may include the size and shape of the hotspot area, and the azimuth between the hotspot area and a micro base station.

In the embodiment of the present application, hotspot areas on a macrocell network may be obtained in advance. The hotspot areas on the macrocell network may also be obtained by measuring traffic distribution over the entire macrocell.

A2. Using, by the micro base station, at least two beams formed by the high-gain directional antennas to form microcell coverage over the hotspot areas in the at least two macrocells.

In an embodiment, the micro base station may be placed in a certain high-elevation position (for example, on the top of a high building, or on a television (TV) tower) within the coverage of a plurality of macrocells, where the micro base station and a plurality of macro base stations that form the macrocells may be located in different sites.

Specifically, the micro base station may use at least two highly directional beams formed by the high-gain directional antennas to form microcell coverage over the hotspot areas in the at least two macrocells, where each beam may provide microcell coverage over one hotspot area.

In the embodiment of the present application, the beams formed by the high-gain directional antennas provide multiple physical channels such as common control channels, dedicated control channels, and traffic channels of the microcell. The beams are also adapted to transmit data between user equipment in the hotspot areas and the micro base station. Microcells are classified into two types: picocells and Femto cells.

In the first embodiment of the present application, a micro base station may configure beam width and beam directions of high-gain directional antennas according to location information about hotspot areas in macrocells, and directly use beams formed by the high-gain directional antennas to form microcell coverage over the hotspot areas. Compared with the prior art, in this embodiment, the location of the micro base station device may be kept unchanged when locations of hotspot areas in a plurality of macrocells change, and by adjusting the beam width and beam directions of high-gain directional antennas, the micro base station can provide microcell coverage over the changed hotspot areas, thereby making the networking flexible and reducing the network maintenance cost.

Further, in the embodiment of the present application, the number of high-gain directional antennas may be configured flexibly according to the number of hotspot areas that require microcell coverage. If only a few hotspot areas require provisioning of microcell coverage, the micro base station may configure the beam width and beam direction of a high-gain directional antenna according to the location information about the hotspot areas in the at least two macrocells, and use the high-gain directional antenna to provide microcell coverage over all the hotspot areas.

In addition, if many hotspot areas require provisioning of microcell coverage, the micro base station may configure the beam width and beam directions of at least two high-gain directional antennas according to the location information about the hotspot areas in the at least two macrocells, and use the at least two high-gain directional antennas to provide microcell coverage for different hotspot areas respectively, so that resources may be flexibly allocated between a plurality of high-gain directional antennas. For example, if in an embodiment the number of hotspot areas in the at least two macrocells is four, beam width and beam directions of two high-gain directional antennas may be configured according to the location information about the four hotspot areas so that each high-gain directional antenna provides microcell coverage for two hotspot areas. Definitely, in another embodiment, beam width and beam directions of four high-gain directional antennas may be configured according to the location information about the four hotspot areas so that each high-gain directional antenna provides microcell coverage for one hotspot area. Definitely, in still another embodiment, beam width and beam directions of three high-gain directional antennas may be configured according to the location information about the four hotspot areas so that one high-gain directional antenna provides microcell coverage for two hotspot areas and the other two high-gain directional antennas provide microcell coverage separately for the other two hotspot areas. Definitely, in other embodiments where the number of high-gain directional antennas is at least two, resources may be flexibly allocated between a plurality of high-gain directional antennas.

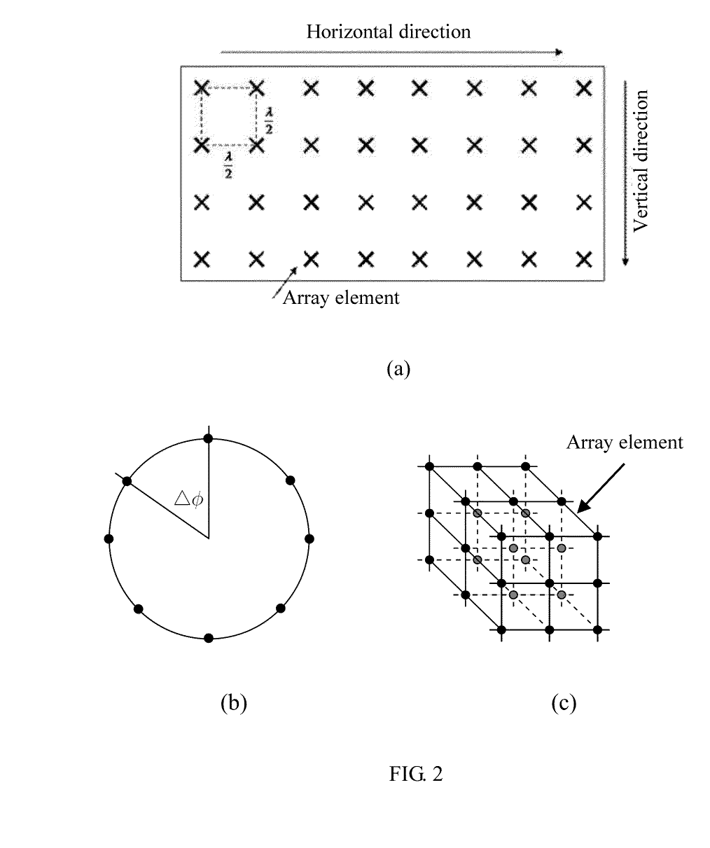

Refer to FIG. 2, which is a schematic diagram of an array antenna according to an embodiment of the present application.

In the embodiment of the present application, high-gain directional antennas used to create microcells may be array antennas, and definitely may also be other types of antennas. For example, if the signal frequency is high, for example, in a microwave frequency band, the high-gain directional antennas may be parabolic antennas. When a linear array is adopted, sectorial microcells may be formed because no beam is formed vertically. When a planar array is adopted, as the 8×4 element even planar array shown in FIG. 2(a), a comparatively narrower beam may be formed both horizontally and vertically at the same time; that is, a three-dimensional (3D) beam is formed. In other words, a beam is formed horizontally and vertically at the same time, thereby facilitating microcell creation. In addition, the circular array shown in FIG. 2(b) and the 3D grid array antenna shown in FIG. 2(c) may also implement 3D beamforming.

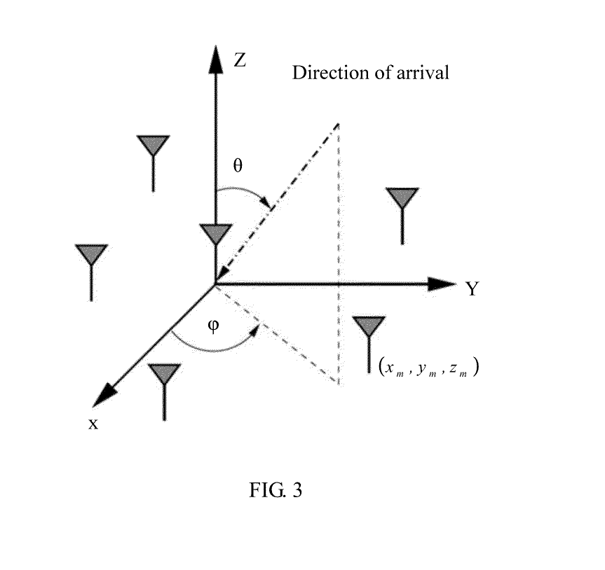

Refer to FIG. 3, which is a schematic diagram of spatial coordinates of array elements in an array antenna according to an embodiment of the present application.

As shown in FIG. 3, for an array antenna with any array geometry and having m array elements, the coordinate origin is an array element numbered 1, and the mth array element is located at (xₘ, yₘ, zₘ), where if the direction of arrival of a certain far-field signal is (φ,θ), the signal may be represented as a vector in the following format:

u(t)=[u₁(t), u₂(t), . . . , u_{M}(t)],

where uₘ (t), m=1, 2, . . . M indicates the receive (or transmit) signal of the m^{th} array element, then the relationship between signals of all array elements is given by:

uₘ(t)=u₁(t)aₘ(φ,θ),

where

$${a}_{m} ( ϕ , θ ) = {e}^{- j \frac{2 π}{λ} f ( ϕ , θ , {x}_{m} , {y}_{m} , {z}_{m} )} ,$$

indicating the phase difference between signals of all array elements. The phase difference is determined by a function ƒ(φ,θ,xₘ,yₘ,zₘ) of the array element location and direction of arrival. For ease of description, the phase difference between signals of all array elements may be given by a vector in the following format:

$$a ( ϕ , θ ) = [ \begin{matrix}1 \\ {a}_{2} ( ϕ , θ ) \\ ⋮ \\ {a}_{M} ( ϕ , θ )\end{matrix} ] .$$

The following equation may be obtained by using a complex weight vector w=(w₁, w₂, . . . , w_{M}) to perform weighted summation for signals of all array elements:

$$v ( t ) = {u}_{1} ( t ) {\sum }_{m = 1}^{M} {w}_{m}^{*} {e}^{- j \frac{2 π}{λ} f ( ϕ , θ , {x}_{m} , {y}_{m} , {z}_{m} )} = {u}_{1} ( t ) ( {w}_{1}^{*} , {w}_{2}^{*} , … {w}_{M}^{*} ) [ \begin{matrix}1 \\ {a}_{2} ( ϕ , θ ) \\ ⋮ \\ {a}_{M} ( ϕ , θ )\end{matrix} ] = {w}^{H} u ( t ) .$$

It can be easily seen that wanted signals from the direction of arrival (φ,θ) may be maximized and interference signals from other directions may be suppressed by selecting a proper weight vector w, where, for the overall array antenna, the process is equivalent to generating beams in a particular direction. The weighted summation operation may be implemented for radio frequency signals or implemented for baseband signals, where the implementation at the baseband is usually called digital beamforming. Beamforming may be implemented in both the receive and transmit directions. A number of mature beamforming algorithms, that is, algorithms for calculating the weight vector w may be used. The present application is not limited to particular beamforming algorithms.

Different from common self-adaptive array antenna systems where beams need to trace every user, beams in the present application do not trace users, but instead, only comparatively fixed beams are formed directing toward certain hotspot areas, and because the hotspot areas within certain periods of time (several hours, days, or months) are comparatively fixed, it is unnecessary to change the beams dynamically and quickly radio frame by radio frame. Therefore, in the embodiment of the present application, beamforming may be implemented directly at intermediate or radio frequencies, making digital beamforming at the baseband unnecessary, and therefore, reducing costs. Each beam needs to be processed at only one baseband, thereby reducing the complexity.

In addition, if the method according to the embodiment of the present application is used to provide microcell coverage over two or more hotspot areas in at least two macrocells, different microcells are capable of sharing a group of array antennas, and the overall beamforming weight vector is the sum of the beamforming weight vectors of all microcells. Taking downlink transmit beamforming as an example, if two microcells separately directing toward (φ₁,θ₁) and (φ₂,θ₂) are located in different places, transmit signals are u₁(t) and u₂(t) respectively, weight vectors w₁ and w₂ are used respectively to perform weight summation, the transmit signal vector is:

s(t)=w*₁u₁(t)+w*₂u₂(t).

Then in the direction of arrival (φ₁,θ₁), signals received by user equipment are given by:

y₁(t)=a(φ₁θ₁)^{T}s(t)+n₁(t)=a(φ₁,θ₁)^{T}w*₁u*₁(t)+a(φ₁,θ₁)^{T}w*₂u₂(t)+n₁(t),

where n₁(t) is a noise signal. If a proper beamforming algorithm is used so that the interference component power |a(φ₁,θ₁)^{T}w*₂|² is minimized and the signal component power) |a(φ₁,θ₁)^{T}w*₁|² is maximized, the user equipment in the direction of arrival (φ₁,θ₁) receives only wanted signals without suffering from interference from signals in other microcells. Similarly, the same method also applies to another microcell, that is, design two weight vectors w₁ and w₂, and maximize the Signal-to-interference Plus Noise Ratio (SINR) as follows:

$${SINR}_{1} = \frac{{\vert {a ( {ϕ}_{1} , {θ}_{1} )}^{T} {w}_{1}^{*} \vert}^{2}}{{\vert {a ( {ϕ}_{1} , {θ}_{1} )}^{T} {w}_{2}^{*} \vert}^{2} + {σ}_{1}^{2}}$$

$${SINR}_{2} = \frac{{\vert {a ( {ϕ}_{1} , {θ}_{1} )}^{T} {w}_{2}^{*} \vert}^{2}}{{\vert {a ( {ϕ}_{1} , {θ}_{1} )}^{T} {w}_{1}^{*} \vert}^{2} + {σ}_{2}^{2}} ,$$

where σ₁² and σ₂² are noise powers. A similar method may also be implemented in the uplink receive direction because reception and transmission are in pair, where uplink and downlink directions, that is, receive and transmit directions, may use a same or different beamforming vectors, where beam directions and beam width may be configured by adjusting beamforming weight factors (generally the phase). In addition, beam directions may also be configured by electrically adjusting down-tile angles and horizontal directions of array antennas.

In the embodiment of the present application, information about hotspot areas in a macrocell including their locations and sizes are obtained by measuring traffic distribution over the entire macrocell for a long time. The embodiment of the present application may implement system networking optimization conveniently by adjusting the beams (direction, beam width, transmit power, and so on) of the array antennas, thereby achieving flexible service adaptability.

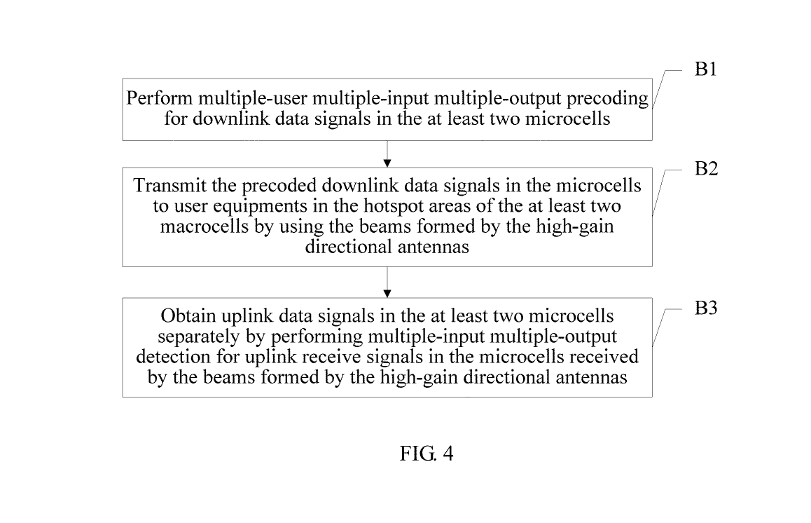

Refer to FIG. 4, which is a flow chart of a method for forming microcell coverage over hotspot areas by using beams formed by high-gain directional antennas according to the first embodiment of the present application.

In the embodiment of the present application, interference may exist between downlink data signals of a plurality of microcells provided by the high-gain directional antennas, the step of using, by the micro base station, at least two beams formed by the high-gain directional antennas to form microcell coverage over the at least two hotspot areas (step A2) may specifically include:

B1. Performing multiple-user multiple-input multiple-output precoding for downlink data signals in the at least two microcells.

Specifically, the multiple-user multiple-input multiple-output (MU-MIMO) precoding according to the embodiment of the present application may be performed for the downlink data signals in the at least two microcells, and after the precoding is complete, step B2 is performed.

B2. Transmitting the precoded downlink data signals in the microcells to user equipment in the hotspot areas of the at least two macrocells by using the beams formed by the high-gain directional antennas.

Specifically, after the multiple-user multiple-input multiple-output precoding according to the embodiment of the present application is performed, the precoded downlink data signals in the microcells are transmitted to the user equipment in the hotspot areas of the at least two macrocells by using the beams formed by the high-gain directional antennas.

In the embodiment of the present application, interference between downlink data signals in different microcells may be eliminated by setting a proper precoding vector, thereby further improving communications system capacity.

In the embodiment of the present application, interference may occur between uplink data signals in different microcells.

The step of using at least two beams formed by the high-gain directional antennas to form microcell coverage over the hotspot areas in the at least two macrocells (step A2) may specifically further include:

B3. Obtaining uplink data signals in the at least two microcells separately by performing multiple-input multiple-output detection for uplink receive signals in the microcells received by the beams formed by the high-gain directional antennas.

Specifically, in the embodiment of the present application, the micro base station may also obtain uplink data signals in the at least two microcells separately by performing multiple-input multiple-output (MIMO) detection for uplink receive signals in the microcells received by the beams formed by high-gain directional antennas. It should be noted that there is no strict order to execute step B3 and steps B1 and B2 according to the embodiment of the present application, that is, step B3 may be performed before step B1, and may also be performed between step B1 and step B2.

In the embodiment of the present application, interference between the uplink data signals in the microcells may be eliminated by using the multiple-input multiple-output detection method, thereby further improving communications system capacity.

Refer to FIG. 5, which is a schematic diagram of an equivalent MIMO channel between microcells according to an embodiment of the present application.

In the embodiment of the present application, when a micro base station adopts a plurality of independent array antennas, a plurality of hotspot areas within the coverage of the micro base station are classified into a plurality of groups, microcell coverage is provided to each group of hotspot areas by an independent array antenna, and equivalent MIMO channels are set up between a plurality of microcells and user equipment corresponding to the microcells.

In the embodiment of the present application, two microcells provided by two array antennas are taken as an example for description purposes. In the embodiment of the present application, they are called a first microcell and a second microcell. The first microcell and the second microcell use different base station transceivers, where h11 and h22 are channel factors respectively from the base station transceiver in the first microcell to user equipment (UE) 1 and from the base station transceiver in the second microcell to UE 2, and h12 and h21 are channel factors respectively from the base station transceiver in the first microcell to UE 2 and from the base station transceiver of the second microcell to UE 1. In the downlink direction, signals from the base station transceiver of the first microcell to UE 1 and from the base station transceiver of the second microcell to UE 2 are wanted signals, and signals from the base station transceiver of the first microcell to UE 2 and from the base station transceiver of the second microcell to UE 1 are interfering signals. In the embodiment of the present application, the MU-MIMO precoding technology may be used to suppress or even eliminate interfering signals by setting a proper precoding vector.

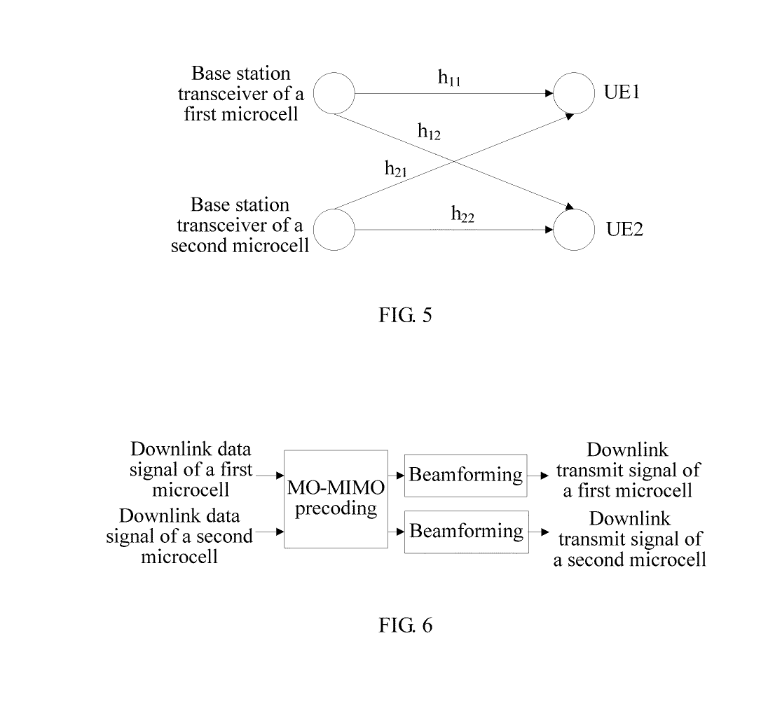

Refer to FIG. 6, which is a schematic diagram of eliminating downlink interference signals in a method for creating a microcell according to an embodiment of the present application.

In the embodiment of the present application, FIG. 6 shows the process of performing interference elimination by using the MU-MIMO precoding. At first downlink data signals in the first microcell and downlink data signals in the second microcell are sent to an MU-MIMO precoding unit for precoding, and the precoded downlink data signals of the first microcell are beamformed to form downlink transmit signals in the first microcell and then transmitted. The precoded downlink data signals of the second microcell are beamformed to form downlink transmit signals of the section microcell and then transmitted.

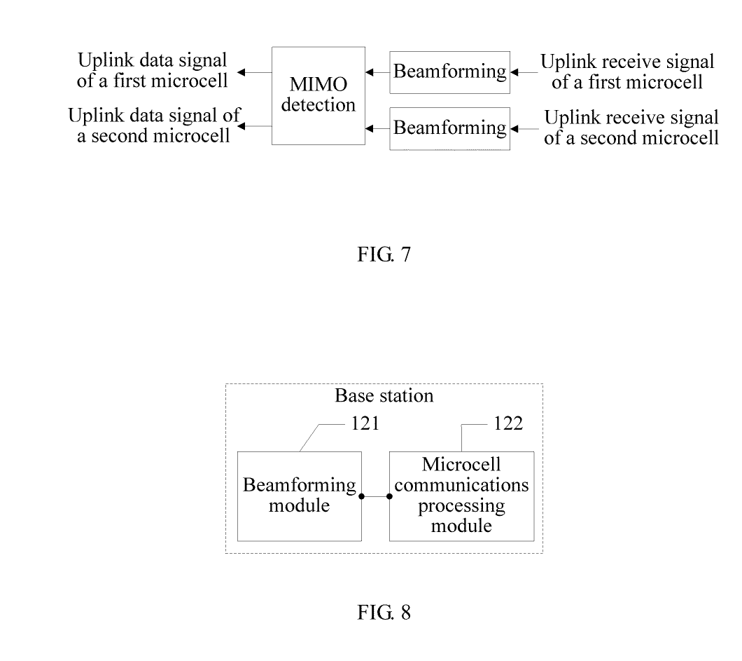

Refer to FIG. 7, which is a schematic diagram of eliminating uplink interference signals in a method for creating a microcell according to an embodiment of the present application.

In the embodiment of the present application, the uplink direction and the downlink direction are in parallel. In the uplink direction, signals from UE 1 to the base station transceiver of the first microcell and from UE 2 to the base station transceiver of the second microcell are wanted signals, signals from UE 1 to the base station transceiver of the second microcell and from UE 2 to the base station transceiver of the first microcell are interfering signals. The MIMO detection technology may be used in the embodiment of the present application to suppress or even eliminate the interfering signals at the base station side. As shown in the figure, after the micro base station first performs beamforming for uplink receive signals in the first microcell and uplink receive signals in the second microcell of all high-gain directional antennas, the MIMO detection unit eliminates interference and isolates wanted signals respectively, that is, uplink data signals of the first microcell and uplink data signals of the second microcell are isolated.

In the embodiment of the present application, microcell coverage is provided by a micro base station device for a plurality of hotspot areas in macrocells. In the micro base station device, high-gain directional antennas are centrally placed in a certain comparative high-elevation position within the coverage of one or more macrocells, for example, on the top of a high building or on a TV tower within the coverage. In the embodiment of the present application, the micro base station and macro base stations may be built at different places, which facilitates selecting of a comparatively high-elevation position within the coverage for building the high-gain directional antennas in the micro base station, and therefore, facilitates forming of comparatively narrower beam width, thereby improving the accuracy of forming microcell coverage by using beams, reducing the size of interference areas between macrocells and microcells, and facilitating system capacity expansion.

The preceding describes in detail the method for creating a microcell according to the embodiment of the present application. The following further describes a base station provided by an embodiment of the present application.

Refer to FIG. 8, which is a schematic structural diagram of a micro base station according to a second embodiment of the present application.

The micro base station according to the second embodiment of the present application includes: a beamforming module 121 and a microcell communications processing module 122, where the beamforming module 121 is adapted to configure beam width and beam directions of high-gain directional antennas according to location information about hotspot areas in at least two macrocells, and the microcell communications processing module 122 is adapted to use at least two beams formed by the high-gain directional antennas to form microcell coverage over the hotspot areas in the at least two macrocells.

The micro base station according to the second embodiment of the present application may be used in the corresponding first embodiment. For details, refer to the first embodiment. The micro base station according to the second embodiment of the present application may be used to configure beam width and beam directions of high-gain directional antennas according to location information about hotspot areas in macrocells, and directly use beams formed by the high-gain directional antennas to form microcell coverage over the hotspot areas. Compared with the prior art where a new site needs to be selected for the micro base station, in the embodiment of the present application, the location of the micro base station may be kept unchanged when locations of hotspot areas in a plurality of macrocells change, and by adjusting the beam width and beam directions of high-gain directional antennas, the micro base station can provide microcell coverage over the changed hotspot areas, thereby making the networking flexible and reducing the network maintenance cost.

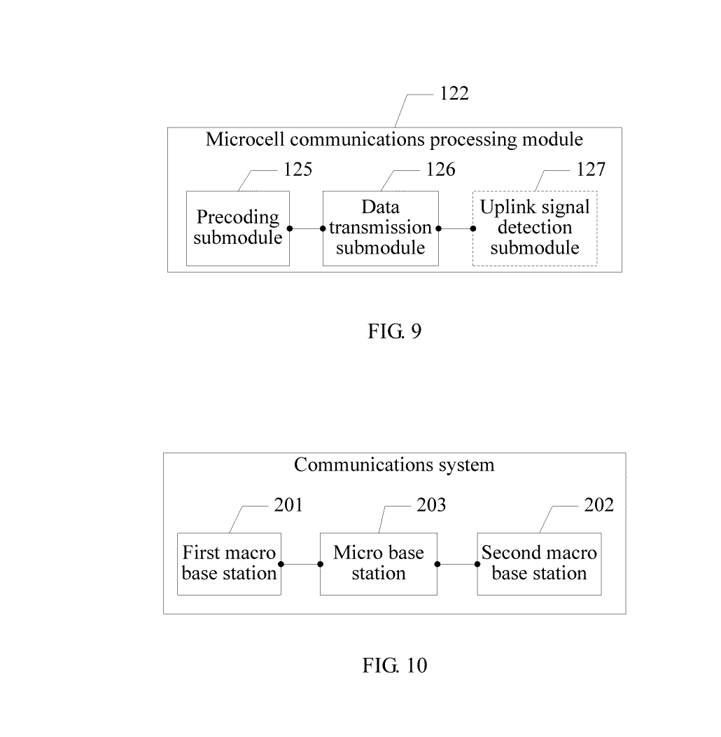

Refer to FIG. 9, which is a schematic structural diagram of the microcell communications processing module in the micro base station according to the second embodiment of the present application, where the microcell communications processing module 122 in the micro base station according to the second embodiment of the present application includes: a precoding submodule 125 adapted to perform multiple-user multiple-input multiple-output precoding for downlink data signals in the at least two microcells; and a data transmission submodule 126 adapted to transmit the precoded downlink data signals in the microcells to user equipment in the hotspot areas of the at least two macrocells by using the beams formed by the high-gain directional antennas.

Further, the microcell communications processing module 122 may also include: an uplink signal detection submodule 127 adapted to obtain uplink data signals in the at least two microcells separately by performing multiple-input multiple-output detection for uplink receive signals in the microcells received by the beams formed by the high-gain directional antennas.

Further, the configuring, by the beamforming module 121 in the micro base station according to the embodiment of the present application, beam width and beam directions of high-gain directional antennas according to location information about hotspot areas in at least two macrocells includes: configuring, by the beamforming module 121, the beam width and beam directions of at least two high-gain directional antennas according to the location information about the hotspot areas in the at least two macrocells, or configuring, by the beamforming module 121, the beam width and beam direction of a high-gain directional antenna according to the location information about the hotspot areas in the at least two macrocells.

During specific applications of the base station provided by the embodiment of the present application, hotspot areas in the coverage may be classified into a plurality of groups, microcell coverage is provided to each group of hotspot areas by an independent beamforming module and microcell communications processing module. The beamforming module may be adapted to configure beam width and beam directions of one or more high-gain directional antennas. Different microcell processing communications modules are capable of visiting each other through a high-speed link, which facilitates implementation of joint resource scheduling and interference management between macrocells.

The base station according to the embodiment of the present application may also integrate the microcell communications processing modules together, thereby implementing statistical multiplexing of processing resources, and reducing the equipment cost, system fault rate, and maintenance cost.

Refer to FIG. 10, which is a schematic structural diagram of a communications system according to a third embodiment of the present application.

The third embodiment of the present application further provides a communications system, where the communications system includes at least two macro base stations 201 and 202, and a micro base station 203.

The at least two macro base stations are respectively a first macro base station 201 and a second macro base station 202. Interconnection links are configured respectively between the first macro base station 201 and the micro base station 203, and between the second macro base station 202 and the micro base station 203. The first macro base station 201 and the second macro base station 202 are adapted to create at least two macrocells. The micro base station 203 in the communications system is the same as the micro base station in the second embodiment. For details, refer to the second embodiment.

In the communications system according to the embodiment of the present application, the micro base station may configure beam width and beam directions of high-gain directional antennas according to location information about hotspot areas in macrocells, and directly use beams formed by the high-gain directional antennas to form microcell coverage over the hotspot areas. Compared with the prior art where a new site needs to be selected for the micro base station, in the embodiment of the present application, the location of the micro base station may be kept unchanged when locations of hotspot areas in a plurality of macrocells change, and by adjusting the beam width and beam directions of high-gain directional antennas, the micro base station can provide microcell coverage over the changed hotspot areas, thereby making the networking flexible and reducing the network maintenance cost.

Further, in the embodiment of the present application, interconnection links may be implemented by using microwaves, free-space lasers, optical fibers, or other intermediate-speed or low-speed lines. Information sharing, for example, sharing of downlink transmit data, uplink receive signals, or channel state information, may be implemented between the macro base stations and the micro base station by configuring interconnection links between the macro base stations and the micro base station. Therefore, the embodiment of the present application allows more reasonable allocation of system resources, according to the shared information, thereby increasing the system capacity.

It should be noted that, the content, such as information exchange and execution process between units in the preceding apparatuses and system, is based on the same conception as the method embodiments of the present application. Therefore, for details about the content, refer to the description in the method embodiments of the present application, so the details will not be described herein again.

Persons of ordinary skill in the art may understand that all or a part of the processes of the methods in the embodiments may be implemented by a computer program instructing relevant hardware. The program may be stored in a computer readable storage medium. When the program is run, the processes of the methods in the embodiments are performed. The storage medium may be a magnetic disk, an optical disk, a read-only memory (ROM), a random access memory (RAM), and the like.

A method, a micro base station, and a communications system for creating a microcell that are provided in the embodiments of the present application are introduced in detail in the foregoing. Persons of ordinary skill in the art may make modifications to the specific implementation manners and application scopes according to the idea of the embodiments of the present application. In conclusion, the content of the specification should not be considered as a limitation to the present application.

What is claimed is:

1. A method for creating a microcell based on coverage of macrocell networks comprising:
configuring, by a micro base station, beam width and beam directions of high-gain directional antennas according to location information about hotspot areas in at least two macrocells; and
using, by the micro base station, at least two beams formed by the high-gain directional antennas to form microcell coverage over the hotspot areas in the at least two macrocells.

2. The method according to claim 1, wherein using, by the micro base station, the at least two beams formed by the high-gain directional antennas to form the microcell coverage over the hotspot areas in the at least two macrocells comprises:
performing, by the micro base station, multiple-user multiple-input multiple-output precoding for downlink data signals in the at least two microcells; and
transmitting, by the micro base station, the precoded downlink data signals in the microcells to user equipment in the hotspot areas of the at least two macrocells by using the beams formed by the high-gain directional antennas.

3. The method according to claim 2, wherein using, by the micro base station, the at least two beams formed by the high-gain directional antennas to form the microcell coverage over the hotspot areas in the at least two macrocells further comprises obtaining, by the micro base station, uplink data signals in the at least two microcells separately by performing multiple-input multiple-output detection for uplink receive signals in the microcells received by the beams formed by the high-gain directional antennas.

4. The method according to claim 1 wherein the high-gain directional antennas comprise array antennas.

5. The method according to claim 1, wherein configuring, by the micro base station, the beam width and the beam directions of the high-gain directional antennas according to the location information about the hotspot areas in the at least two macrocells comprises:
configuring, by the micro base station, the beam width and the beam directions of at least two high-gain directional antennas according to the location information about the hotspot areas in the at least two macrocells; or
configuring, by the micro base station, the beam width and the beam direction of a high-gain directional antenna according to the location information about the hotspot areas in the at least two macrocells.

6. A micro base station comprising:
a beamforming module adapted to configure beam width and beam directions of high-gain directional antennas according to location information about hotspot areas in at least two macrocells; and
a microcell communications processing module adapted to use at least two beams formed by the high-gain directional antennas to form microcell coverage over the hotspot areas in the at least two macrocells.

7. The micro base station according to claim 6, wherein the microcell communications processing module comprises:
a precoding submodule adapted to perform multiple-user multiple-input multiple-output precoding for downlink data signals in the at least two microcells; and
a data transmission submodule adapted to transmit the precoded downlink data signals in the microcells to user equipment in the hotspot areas of the at least two macrocells by using the beams formed by the high-gain directional antennas.

8. The micro base station according to claim 7, wherein the microcell communications processing module further comprises an uplink signal detection submodule adapted to obtain uplink data signals in the at least two microcells separately by performing multiple-input multiple-output detection for uplink receive signals in the microcells received by the beams formed by the high-gain directional antennas.

9. The micro base station according to claim 6, wherein the beamforming module is specifically adapted to:
configure the beam width and the beam directions of at least two high-gain directional antennas according to the location information about the hotspot areas in the at least two macrocells; or
configure the beam width and the beam direction of a high-gain directional antenna according to the location information about the hotspot areas in the at least two macrocells.

10. A communications system comprising:
at least two macro base stations, wherein the at least two macro base stations are adapted to create at least two macrocells; and
a micro base station,
wherein the micro base station comprises a beamforming module and a microcell communications processing module,
wherein the beamforming module is adapted to configure beam width and beam directions of high-gain directional antennas according to location information about hotspot areas in the at least two macrocells,
wherein the microcell communications processing module is adapted to use at least two beams formed by the high-gain directional antennas to form microcell coverage over the hotspot areas in the at least two macrocells, and
wherein interconnection links are separately configured between the at least two macro base stations and the micro base station.
